(19) United States
(12) Patent Application Publication
(10) Pub. No.: US 2023/0352747 A1
(43) Pub. Date: Nov. 2, 2023

(54) Bipolar Storage Battery

(71) Applicants: Furukawa Electric Co., Ltd., Tokyo (JP); The Furukawa Battery Co., Ltd., Yokohama (JP)

(72) Inventors: Hiroki Tanaka, Tokyo (JP); Yasuo Nakajima, Tokyo (JP); Kenichi Suyama, Tokyo (JP); Akira Tanaka, Tokyo (JP)

(21) Appl. No.: 18/332,486

(22) Filed: Jun. 9, 2023

Related U.S. Application Data
(63) Continuation of application No. PCT/JP2021/040256, filed on Nov. 1, 2021.

(30) Foreign Application Priority Data
Dec. 10, 2020 (JP) 2020-204827

(51) Int. Cl. H01M 4/68; H01M 50/198; H01M 10/18

(52) U.S. Cl. CPC H01M 10/18; H01M 4/685; H01M 50/198

(57) ABSTRACT

A bipolar storage battery includes a bipolar electrode including a positive electrode, a negative electrode, and a bipolar plate provided with the positive electrode on one surface and the negative electrode on another surface. The bipolar storage battery includes an adhesive provided between the one surface of the bipolar plate and the positive electrode to bond the positive electrode to the bipolar plate, and the adhesive is a liquid gasket. This configuration can provide a bipolar storage battery in which, even if corrosion by sulfuric acid contained in an electrolytic solution causes a growth in a positive electrode, the electrolytic solution is prevented from easily entering each part such as an interface between the positive electrode, an adhesive, and a communication hole, and battery performance is less likely to deteriorate.

### CROSS-REFERENCE TO RELATED APPLICATION(S)

This application is a continuation of PCT Application No. PCT/JP2021/040256, filed Nov. 1, 2021, the disclosure of which is incorporated herein in its entirety by reference.

### TECHNICAL FIELD

Embodiments of the present invention relate to a bipolar storage battery.

### BACKGROUND

In a conventional lead-acid storage battery, for example, a substrate (hereinafter, this substrate may be referred to as a “bipolar plate”) made of resin is attached inside a frame (rim) made of resin having a picture frame shape. A positive lead layer and a negative lead layer are disposed on one surface and another surface of the bipolar plate. A positive active material layer is adjacent to the positive lead layer. A negative active material layer is adjacent to the negative lead layer.

That is, as illustrated in FIG. 6A, for example, the positive electrode of the conventional bipolar electrode is configured such that a positive lead layer 220 is disposed on one surface of a bipolar plate 210 made of resin with an adhesive layer 240 interposed therebetween, and a positive active material layer (not illustrated) is disposed on the positive lead layer 220. In addition, a glass mat (electrolytic layer) containing an electrolytic solution is disposed inside a spacer made of resin having a picture frame shape. Then, a plurality of frames and spacers is alternately stacked and assembled.

Further, the positive lead layer and the negative lead layer may be joined inside a plurality of perforations formed in the bipolar plate. Such a lead-acid storage battery is a bipolar lead-acid storage battery in which a plurality of bipolar plates having perforations (also called communication holes) for communicating one surface side and another surface side and cell members is alternately stacked. The cell member includes a positive electrode in which the positive active material layer is provided on the positive lead layer, a negative electrode in which the negative active material layer is provided on the negative lead layer, and the electrolytic layer interposed between the positive electrode and the negative electrode. The positive lead layer of one cell member and the negative lead layer of another cell member are joined via the communication hole of the bipolar plate, and the cell members are connected in series.

### SUMMARY

In the bipolar lead-acid storage battery as described above, the positive lead layer 220 can be corroded by sulfuric acid contained in the electrolytic solution to generate a coating film 260 of a corrosion product (lead oxide) on the front surface of the positive lead layer 220 (see FIG. 6B). Then, there is a possibility that the development of the coating film 260 of the corrosion product causes elongation (growth) in the positive lead layer 220.

In addition, there is a possibility that the positive lead layer 220 and the adhesive layer 240 are separated due to this growth, the electrolytic solution infiltrates the interface between the positive lead layer 220 and the adhesive layer 240, and the corrosion of the positive lead layer 220 due to sulfuric acid further proceeds (see FIG. 6C). As a result, when corrosion reaches, for example, the back surface of the positive lead layer 220 (the surface facing the bipolar plate 210), there has been a case where a short circuit or the like occurs, and the performance of the battery deteriorates.

In addition, when the positive lead layer and the adhesive layer are separated in the vicinity of the communication hole of the bipolar plate, there is a possibility that the electrolytic solution enters the communication hole, and sulfuric acid enters between the bipolar plate and the negative lead layer via the communication hole to cause liquid junction, a reduction in voltage, and/or deterioration of the performance.

An object of the present invention is to provide a bipolar storage battery in which even when corrosion by sulfuric acid contained in an electrolytic solution causes growth in a positive electrode, the electrolytic solution is prevented from easily entering each part such as an interface between the positive electrode and an adhesive and a communication hole, and the battery performance is less likely to deteriorate.

A bipolar storage battery according to an embodiment of the present invention includes a bipolar electrode including a positive electrode, a negative electrode, and a bipolar plate provided with the positive electrode on one surface and the negative electrode on another surface. The bipolar storage battery includes an adhesive provided between the one surface of the bipolar plate and the positive electrode to bond the positive electrode to the bipolar plate, and the adhesive is a liquid gasket.

According to the present invention, it is possible to provide a bipolar storage battery in which, even when corrosion by sulfuric acid contained in an electrolytic solution causes growth in a positive electrode, the electrolytic solution is prevented from easily entering each part such as an interface between the positive electrode, an adhesive, and a communication hole, and the battery performance is less likely to deteriorate.

### BRIEF DESCRIPTION OF THE DRAWINGS

FIG. 1 is a cross-sectional view illustrating a structure of a bipolar lead-acid storage battery according to an embodiment of the present invention.

FIG. 2 is an enlarged cross-sectional view of a bipolar electrode illustrating a structure of a main part of a bipolar lead-acid storage battery according to a first embodiment.

FIG. 3 is an enlarged cross-sectional view of a bipolar electrode illustrating a structure of a main part of a bipolar lead-acid storage battery according to a second embodiment.

FIG. 4 is an enlarged cross-sectional view of a bipolar electrode illustrating a structure of a main part of a bipolar lead-acid storage battery according to a third embodiment.

FIG. 5 is a plan view of the bipolar electrode illustrating a structure of a main part of the bipolar lead-acid storage battery according to the third embodiment.

FIGS. 6A, 6B, and 6C are views illustrating a state in which an electrolytic solution infiltrates an interface between a positive lead layer and an adhesive layer as a result of growth occurring in the positive lead layer due to corrosion by sulfuric acid contained in the electrolytic solution in a conventional bipolar lead-acid storage battery.

### DETAILED DESCRIPTION

Hereinafter, embodiments of the present invention will be described in detail with reference to the drawings. Note that the embodiments described below illustrate an example of the present invention. In addition, various changes or improvements can be added to the present embodiments, and a mode to which such changes or improvements are added can also be included in the present invention. These embodiments and modifications thereof are included in the scope and gist of the invention and are included in the scope of the invention described in the claims and its equivalents. Note that, hereinafter, a lead-acid storage battery will be described as an example from among various storage batteries.

### First Embodiment

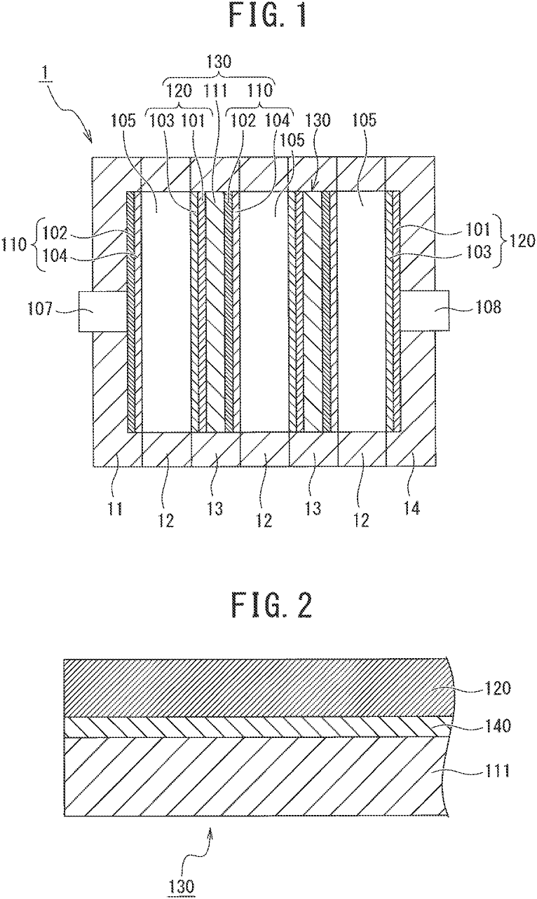

A structure of a bipolar lead-acid storage battery 1 according to embodiments of the present invention will be described with reference to FIG. 1. FIG. 1 is a cross-sectional view describing a structure of the bipolar lead-acid storage battery 1 according to embodiments of the present invention.

The bipolar lead-acid storage battery 1 illustrated in FIG. 1 includes a first plate unit in which a negative electrode 110 is fixed to a first plate 11 (also called an endplate) having a flat plate shape, a second plate unit in which an electrolytic layer 105 is fixed to the inside of a second plate 12 (also called a spacer) having a frame plate shape, a third plate unit in which a bipolar electrode 130 having a positive electrode 120 provided on one surface of a bipolar plate 111 and a negative electrode 110 provided on another surface is fixed to the inside of a third plate 13 (also called a rim) having a frame plate shape, and a fourth plate unit in which the positive electrode 120 is fixed to a fourth plate 14 (also called an endplate) having a flat plate shape.

The second plate unit and the third plate unit are alternately stacked between the first plate unit and the fourth plate unit to form the bipolar lead-acid storage battery 1 having, for example, a substantially rectangular parallelepiped shape. The number of each of the second plate units and the third plate units to be stacked is set such that the storage capacity of the bipolar lead-acid storage battery 1 has a desired numerical value.

A negative terminal 107 is fixed to the first plate 11, and the negative electrode 110 and the negative terminal 107 fixed to the first plate 11 are electrically connected. A positive terminal 108 is fixed to the fourth plate 14, and the positive electrode 120 and the positive terminal 108 fixed to the fourth plate 14 are electrically connected.

The first plate 11, the second plate 12, the third plate 13, and the fourth plate 14 are formed of, for example, a well-known molded resin. The first plate 11, the second plate 12, the third plate 13, and the fourth plate 14 are fixed to each other by an appropriate method so that the inside is in a sealed state, and the electrolytic solution does not flow out.

The electrolytic layer 105 is made of, for example, a glass fiber mat impregnated with an electrolytic solution containing sulfuric acid.

The bipolar plate 111 is made of, for example, thermoplastic resin. Examples of the thermoplastic resin forming the bipolar plate 111 include acrylonitrile-butadiene-styrene copolymer (ABS) resin or polypropylene. These thermoplastic resins are excellent in moldability and in sulfuric acid resistance. Hence, even when the electrolytic solution contacts the bipolar plate 111, decomposition, deterioration, corrosion, and the like hardly occur in the bipolar plate 111.

The positive electrode 120 includes the positive lead layer 101, which is a positive current collector made of lead or a lead alloy and arranged on the one surface of the bipolar plate 111, and a positive active material layer 103 arranged on the positive lead layer 101. This positive lead layer 101 is bonded to the one surface of the bipolar plate 111 by an adhesive 140 provided between the one surface of the bipolar plate 111 and the positive lead layer 101. Accordingly, the adhesive 140, the positive lead layer 101, and the positive active material layer 103 are stacked in this order on the one surface (in the drawings such as FIG. 2 to be described below, a surface facing upward on the plane of paper) of the bipolar plate 111.

The negative electrode 110 includes the negative lead layer 102, which is a negative current collector made of lead or a lead alloy and arranged on the other surface of the bipolar plate 111, and a negative active material layer 104 arranged on the negative lead layer 102. This negative lead layer 102 is bonded to the other surface of the bipolar plate 111 by an adhesive 140 provided between the other surface of the bipolar plate 111 and the negative lead layer 102. The positive electrode 120 and negative electrode 110 are electrically connected by an appropriate method such as via a communication hole provided in the bipolar plate 111.

In the bipolar lead-acid storage battery 1 of the first embodiment having such a configuration as described above, the bipolar plate 111, the positive lead layer 101, the positive active material layer 103, the negative lead layer 102, and the negative active material layer 104 constitute the bipolar electrode 130. The bipolar electrode is an electrode having both positive and negative electrode functions in one electrode. The bipolar lead-acid storage battery 1 of the embodiment of the present invention has a battery configuration in which a plurality of cell members formed by interposing the electrolytic layer 105 between the positive electrode 120 and the negative electrode 110 is alternately stacked and assembled to connect the cell members in series.

FIG. 2 is an enlarged cross-sectional view of a bipolar electrode 130 illustrating a structure of a main part of a bipolar lead-acid storage battery 1 according to the first embodiment. Note that, in the cross-sectional view of the bipolar electrode 130 as illustrated, for example, in FIG. 2 described below, the positive lead layer 101 and the positive active material layer 103 are collectively illustrated as the positive electrode 120. In addition, in the bipolar electrode 130 in FIG. 2, for example, structures other than the bipolar plate 111, the adhesive 140, and the positive electrode 120, such as the negative electrode 110 provided on the other surface of the bipolar plate 111, are not illustrated.

In the bipolar electrode 130 according to the embodiment of the present invention illustrated in FIG. 2, the positive electrode 120 is bonded onto the one surface of the bipolar plate 111 via a liquid gasket 140 used as an adhesive. Here, the liquid gasket 140 is generally a substance having fluidity at normal temperature, and when it is applied to a joint surface, the liquid gasket 140 is dried or uniformized after a lapse of a predetermined time to form an elastic film or a viscous layer. Furthermore, by application of a certain pressure, irregularities on and gaps in the bonding surface are fully filled, and a sufficient sealing effect can be obtained.

By using the liquid gasket 140 having such sealability as an adhesive, the electrolytic solution is less likely to enter between the bipolar plate 111 and the positive electrode 120, and even if growth occurs in the positive electrode 120, the electrolytic solution is prevented from easily entering each part such as the interface between the positive electrode 120, the liquid gasket 140, and the communication hole. This makes it possible to more effectively prevent deterioration of the battery performance.

Examples of the liquid gasket 140 used as the adhesive include product numbers “TB1184D”, “TB1184E”, “TB 1184J”, “TB 1184Y”, “TB1119A/B”, “TB 1170E”, “TB1170H”, “TB1171G”, “TB1152C”, “TB1153D”, “TB1215”, “TB1207B”, “TB1216E”, “TB1217F”, and “TB1280E” manufactured by ThreeBond Co., Ltd., and “NAFLON® GL (TOMBO brand No. 9007-GL)” and “CLINSIL® Clean (TOMBO brand No. 1133)” manufactured by NICHIAS Corporation. Because sulfuric acid is contained in the electrolytic solution, a liquid gasket 140 having sulfuric acid resistance is preferable. Then, among the above-described adhesives, in particular, the aforementioned “TB 1119A/B” using a fluorine-based resin as a main component, the aforementioned “TB1184D”, “TB1184E”, “TB1184J”, “TB1184Y”, “TB1171G”, and the like using a special synthetic rubber as a main component are more preferable because of favorable sulfuric acid resistance. Among them, the aforementioned “TB1119A/B” and “TB1184D” are most preferred.

As described above, by using the liquid gasket 140 as an adhesive, it is possible to provide the bipolar lead-acid storage battery 1 in which not only the bipolar plate 111 and the positive electrode 120 are bonded to each other, but also the electrolytic solution is prevented from easily entering each part such as the interface between the positive electrode 120, the liquid gasket 140, and the communication hole even when corrosion by sulfuric acid contained in the electrolytic solution causes growth in the positive electrode. As a result, battery performance is less likely to deteriorate.

### Second Embodiment

Next, the second embodiment of the present invention will be described. Note that, in the second embodiment, the same constituent elements as those described in the above-described first embodiment are denoted by the same reference numerals, and redundant description of the same constituent elements will be omitted.

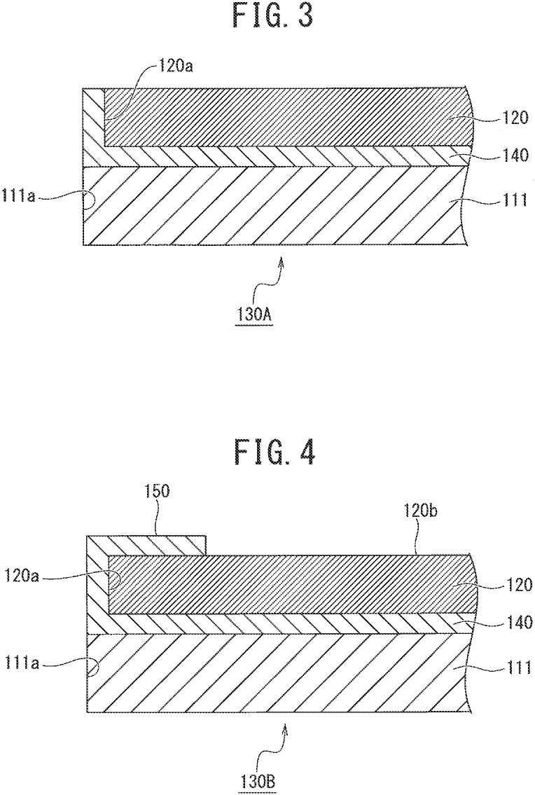

FIG. 3 is an enlarged cross-sectional view of a bipolar electrode 130A illustrating a structure of a main part of a bipolar lead-acid storage battery 1 according to the second embodiment. The bipolar electrode 130A of the second embodiment is different from the bipolar electrode 130 of the first embodiment in terms of the region where the liquid gasket 140 is provided.

That is, the liquid gasket 140 of the bipolar electrode 130A is provided in a flange shape to extend from a peripheral edge portion 111a of the bipolar plate 111 in a direction orthogonal to one surface of a bipolar plate 111 on the one surface of the bipolar plate 111. Therefore, the positive electrode 120 is bonded to the one surface of the bipolar plate 111 via the liquid gasket 140 and is bonded to the liquid gasket 140 at a peripheral edge end portion 120a of the positive electrode 120.

With such an arrangement in the bipolar electrode 130A according to the second embodiment, the positive electrode 120 is in contact with the liquid gasket 140 over two surfaces. As a result, the positive electrode 120 is firmly joined to the bipolar plate 111. Therefore, it is possible to provide the bipolar lead-acid storage battery 1 in which, even when corrosion by sulfuric acid contained in the electrolytic solution causes growth in the positive electrode, the electrolytic solution is prevented from easily entering each part such as an interface between the positive electrode 120, the liquid gasket 140, and the communication hole. The battery performance is less likely to deteriorate.

### Third Embodiment

Next, the third embodiment of the present invention will be described. Note that, in the third embodiment, the same constituent elements as those described in the above-described first or second embodiment are denoted by the same reference numerals, and redundant description of the same constituent elements will be omitted.

FIG. 4 is an enlarged cross-sectional view of a bipolar electrode 130B illustrating a structure of a main part of a bipolar lead-acid storage battery 1 according to the third embodiment. A liquid gasket 140 is also applied onto a surface of a positive electrode 120, the surface being opposite to a surface of the positive electrode 120 bonded to one surface of a bipolar plate 111 (hereinafter, this opposite surface is referred to as an “opposing surface 120b”).

The bipolar electrode 130B includes a covering member 150 that covers a region including a peripheral edge end portion 120a of the positive electrode 120. This covering member 150 is provided so as to cover the peripheral edge end portion 120a of a positive lead layer 101 exposed from a positive active material layer 103. In the third embodiment, the covering member 150 is the liquid gasket 140.

In addition, as described above, the liquid gasket 140 is provided on the one surface of the bipolar plate 111, the surface of the positive electrode 120 opposite to the surface, and in a flange shape with respect to the one surface, and in the bipolar electrode 130B of the third embodiment, the liquid gasket 140 is also provided on the opposing surface 120b. Therefore, the positive electrode 120 of the third embodiment has a structure in which a part thereof is sandwiched by the liquid gasket 140.

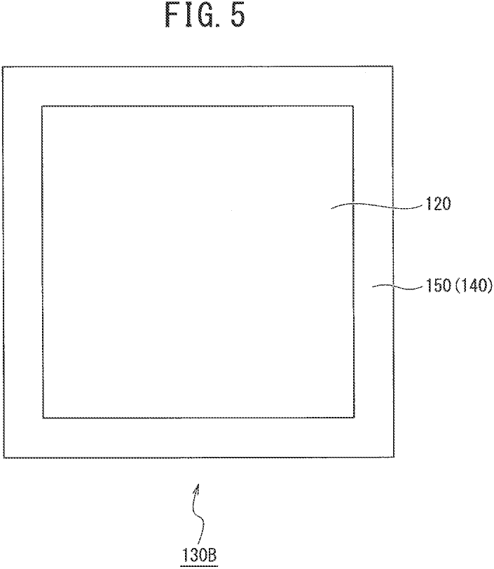

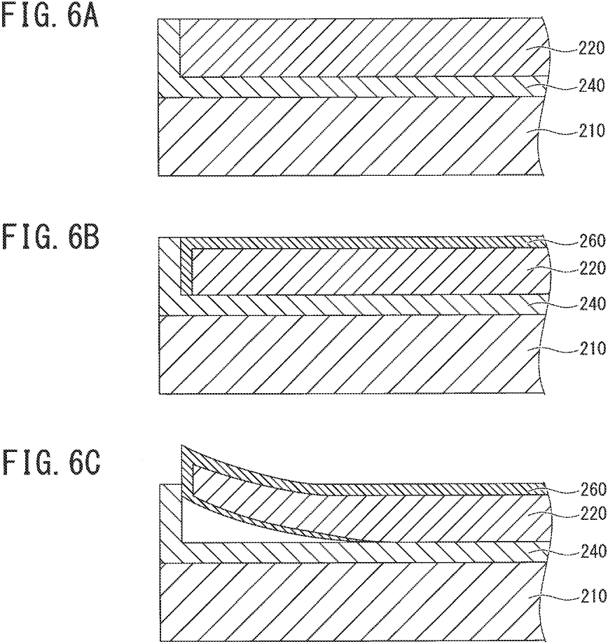

The region of the positive electrode 120 sandwiched by the liquid gasket 140 is a region including the peripheral edge end portion 120a. Accordingly, as illustrated in FIG. 5 as a plan view of the bipolar electrode 130B illustrating a structure of a main part of the bipolar lead-acid storage battery 1 according to the third embodiment, the peripheral edge of the positive electrode 120 is covered in a frame shape by the liquid gasket 140, which is the covering member 150.

By providing the covering member 150 in the region including the peripheral edge end portion 120a of the positive electrode 120 as described above, even if the growth occurs, it is possible to prevent the electrolytic solution from infiltrating the interface between the positive electrode 120 and the liquid gasket 140 to separate them. In addition, by using the liquid gasket 140, which is an adhesive, as the covering member 150, it is not necessary to prepare a special member as the covering member 150.

Note that, as illustrated in FIG. 4, it is assumed that the liquid gasket 140, which is the covering member 150, covering the peripheral edge end portion 120a is integrated to be joined and continuous with the liquid gasket 140 provided between the one surface of the bipolar plate 111 and the positive electrode 120. That is, as described above, the liquid gasket 140 is provided on the one surface of the bipolar plate 111, the surface of the positive electrode 120 opposite to the surface, and in a flange shape with respect to the one surface and extends to the peripheral edge end portion 120a of the positive electrode 120.

As a matter of course, the liquid gasket 140 covering the peripheral edge end portion 120a may be configured separately to not be continuous with the liquid gasket 140 provided on the one surface of the bipolar plate 111, the surface of the positive electrode 120 opposite to the surface, and in a flange shape with respect to the one surface.

Note that, as described above, the description has been made by taking the positive electrode as an example in each embodiment, but the described structure can also be adopted in the negative electrode.

In addition, as described above, in the embodiments of the present invention, a bipolar type lead-acid storage battery has been described as an example. However, when the aforementioned descriptive content applies to other storage batteries in which other metals (for example, aluminum, copper, or nickel), alloys, or conductive resins are used instead of lead for a current collector, such application is naturally not excluded.

The following is a list of reference signs used in this specification and in the drawings.

| | |
|---|---|
| 1 | Bipolar lead-acid storage battery |
| 101 | Positive lead layer |
| 102 | Negative lead layer |
| 103 | Positive active material layer |
| 104 | Negative active material layer |
| 105 | Electrolytic layer |
| 110 | Negative electrode |
| 111 | Bipolar plate |
| 111 a | Peripheral edge portion |
| 120 | Positive electrode |
| 120 a | Peripheral edge end portion |
| 130 | Bipolar electrode |
| 130A | Bipolar electrode |
| 130B | Bipolar electrode |
| 140 | Liquid gasket |
| 150 | Covering member |

What is claimed is:

1. A bipolar storage battery, comprising:
a bipolar electrode including a positive electrode, a negative electrode, and a bipolar plate provided with the positive electrode on one surface and the negative electrode on another surface, wherein:
an adhesive is provided between the one surface of the bipolar plate and the positive electrode to bond the positive electrode to the bipolar plate, and
the adhesive is a liquid gasket.

2. The bipolar storage battery according to claim 1, wherein the positive electrode includes a positive current collector, the negative electrode includes a negative current collector, and the positive current collector and the negative current collector are made of lead or a lead alloy.

3. The bipolar storage battery according to claim 1,
wherein the bipolar electrode includes a covering member configured to cover a peripheral edge end portion of the positive electrode, and
the covering member is a liquid gasket.

4. The bipolar storage battery according to claim 3, wherein the positive electrode includes a positive current collector, the negative electrode includes a negative current collector, and the positive current collector and the negative current collector are made of lead or a lead alloy.

5. The bipolar storage battery according to claim 3, wherein the liquid gasket uses a fluorine-based resin or a special synthetic rubber as a main component.

6. The bipolar storage battery according to claim 5, wherein the positive electrode includes a positive current collector, the negative electrode includes a negative current collector, and the positive current collector and the negative current collector are made of lead or a lead alloy.

7. The bipolar storage battery according to claim 1, wherein the liquid gasket uses a fluorine-based resin or a special synthetic rubber as a main component.

8. The bipolar storage battery according to claim 7, wherein the positive electrode includes a positive current collector, the negative electrode includes a negative current collector, and the positive current collector and the negative current collector are made of lead or a lead alloy.

9. The bipolar storage battery according to claim 1, wherein the adhesive is extended in a direction orthogonal to the one surface from a peripheral edge portion of the bipolar plate on the one surface of the bipolar plate.

10. The bipolar storage battery according to claim 9, wherein the positive electrode includes a positive current collector, the negative electrode includes a negative current collector, and the positive current collector and the negative current collector are made of lead or a lead alloy.

11. The bipolar storage battery according to claim 9, wherein the liquid gasket uses a fluorine-based resin or a special synthetic rubber as a main component.

12. The bipolar storage battery according to claim 11, wherein the positive electrode includes a positive current collector, the negative electrode includes a negative current collector, and the positive current collector and the negative current collector are made of lead or a lead alloy.

13. The bipolar storage battery according to claim 9,
wherein the bipolar electrode includes a covering member configured to cover a peripheral edge end portion of the positive electrode, and
the covering member is a liquid gasket and is joined to the adhesive.

14. The bipolar storage battery according to claim 13, wherein the positive electrode includes a positive current collector, the negative electrode includes a negative current collector, and the positive current collector and the negative current collector are made of lead or a lead alloy.

15. The bipolar storage battery according to claim 13, wherein the liquid gasket uses a fluorine-based resin or a special synthetic rubber as a main component.

16. The bipolar storage battery according to claim 15, wherein the positive electrode includes a positive current collector, the negative electrode includes a negative current collector, and the positive current collector and the negative current collector are made of lead or a lead alloy.
